(19) United States
(12) Patent Application Publication
(10) Pub. No.: US 2026/0370083 A1
(43) Pub. Date: Nov. 19, 2026

(54) HIGH VIBRATION MOTOR

(71) Applicant: MOLON MOTOR AND COIL CORPORATION, Arlington Heights, IL (US)

(72) Inventor: Emilio A. RAMIREZ, Roselle, IL (US)

(73) Assignee: MOLON MOTOR AND COIL CORPORATION, Arlington Heights, IL (US)

(21) Appl. No.: 19/124,233

(22) PCT Filed: Oct. 24, 2023
(86) PCT No.: PCT/US2023/035807

§ 371 Date: Apr. 24, 2025

(51) Int. Cl. H02K 5/24; F16H 57/02; H02K 7/116

(52) U.S. Cl. CPC H02K 5/24; H02K 7/1166; F16H 2057/02034

(57) ABSTRACT

A high vibration motor is provided and is configured to be received within a housing. The motor includes a motor shaft and a notch. The housing includes a gear box; at least one end rib that is configured to prevent the motor from axial movement; at least one radial rib configured to prevent movement of the motor in a radial direction; at least one protrusion to fix in the notch of the motor to prevent radial movement of the motor; and a gear cover configured to be secured to the gear box. A gear train is configured to be received inside of the housing and driven by the motor shaft, where the gear train located on a side of the motor having the motor shaft. A rotatable output shaft extends through a wall of the housing and is rotatably driven by the gear train.

### BACKGROUND

There are many motors performing different functions for different applications. Some of the applications are motors placed in a high vibration environment. Vibrations can be destructive to the motor since the motor has wires and components that are not meant to withstand vibrations. Having a motor in a high vibration environment can thus, have negative consequences on the motor.

### SUMMARY

Embodiments of the present invention provide a motor and case that are configured to withstand a high vibration environment.

Embodiments of the present invention a high vibration motor is provided and is configured to be received within a housing. The motor includes a motor shaft and a notch. The housing includes a gear box; at least one end rib that is configured to prevent the motor from axial movement; at least one radial rib configured to prevent movement of the motor in a radial direction; at least one protrusion to fix in the notch of the motor to prevent radial movement of the motor; and a gear cover configured to be secured to the gear box. A gear train is configured to be received inside of the housing and driven by the motor shaft, where the gear train located on a side of the motor having the motor shaft. A rotatable output shaft extends through a wall of the housing and is rotatably driven by the gear train.

Embodiments of the present invention may have various features and provide various advantages. Any of the features and advantages of the present invention may be desired, but, are not necessarily required to practice the present invention.

### BRIEF DESCRIPTION OF THE DRAWINGS

FIG. 1 is an exterior perspective view of a gear box for an ice dispenser according to the present invention.

FIG. 2 is an interior perspective view of the gear box with a cover removed.

FIG. 3 is a partially exploded perspective view of the gear box.

FIG. 4 is another interior perspective view of the gear box with various components removed.

FIG. 5 is a schematic diagram (circuit layout) of a printed circuit board of the gear box.

FIG. 6 is an exterior perspective view of another embodiment of a gear box for an ice dispenser according to the present invention.

FIG. 7 is an interior perspective view of the embodiment of the gear box of FIG. 6 with the cover removed.

FIG. 8 is a schematic diagram (circuit layout) of a printed circuit board of the gear box of FIG. 6.

FIG. 9 is a side view of a high vibration motor in accordance with some embodiments.

FIG. 10 is a side exploded view of the high vibration motor of FIG. 9 in accordance with some embodiments.

FIG. 11 is a front exploded view of the high vibration motor of FIG. 10 in accordance with some embodiments.

FIG. 12 is a bottom view of the high vibration motor of FIG. 9 in accordance with some embodiments.

FIG. 13 is a front view of the high vibration motor of FIG. 9 taken along line b: Section D-D shown in FIG. 12 in accordance with some embodiments.

FIG. 14 is a top view of the high vibration motor of FIG. 9 with the gear cover removed, in accordance with some embodiments.

FIG. 15 is a front view of the high vibration motor of FIG. 9 taken along line in Section C-C shown in FIG. 12 in accordance with some embodiments.

### DETAILED DESCRIPTION OF THE INVENTION

### First Gear Box Embodiment

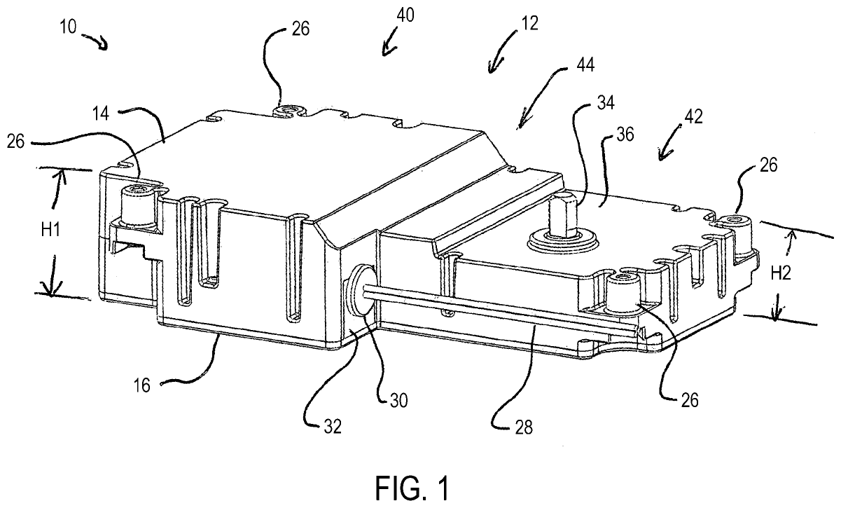

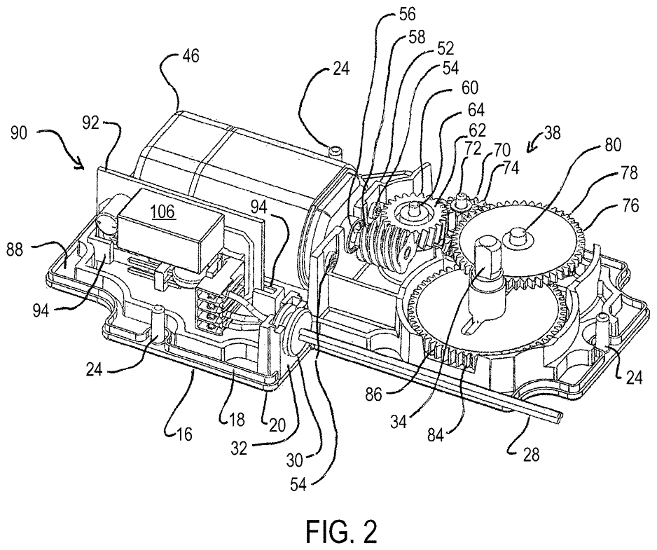

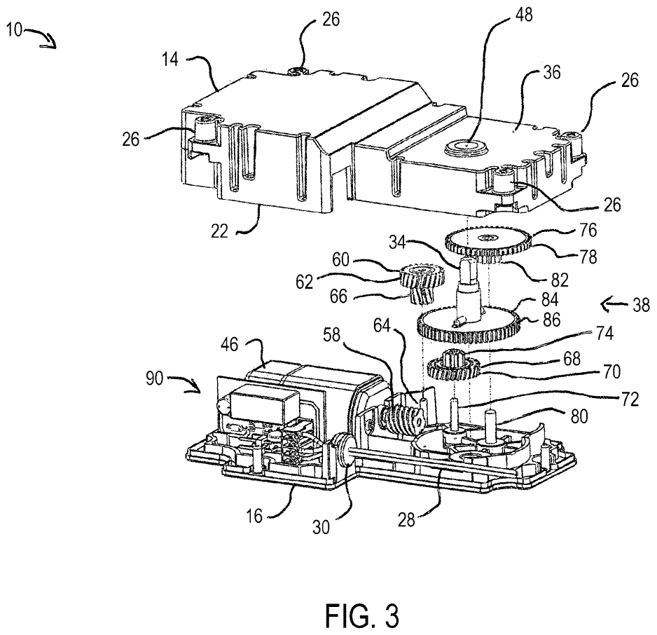

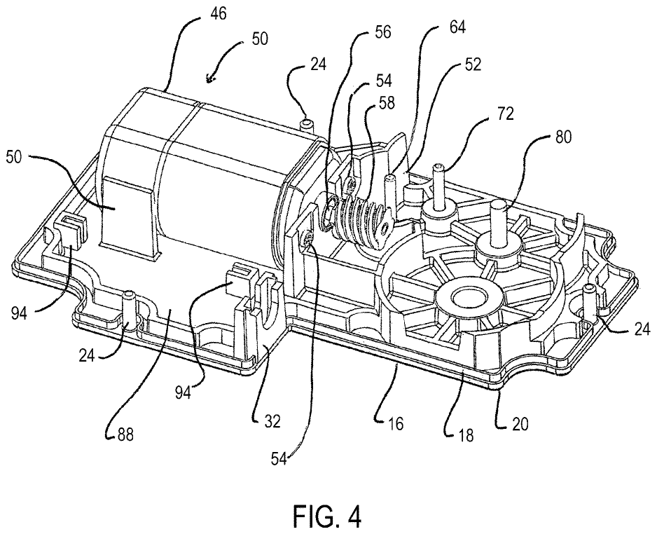

One example of a gear box 10 according to the present invention is shown in FIGS. 1-5. The gear box 10 can be used to drive an ice dispenser for an ice maker of a refrigerator/freezer (not shown). FIG. 1 shows a perspective, exterior view of the gear box 10. The gear box 10 has a closed housing 12 having a cover 14 and a base 16. The cover 14 and the base 16 are made of plastic material; however, any suitable material can be used, for example, metal materials. The cover 14 and the base 16 are attached together by ultrasonic welding. Referring to FIGS. 2 and 4, the base 16 has an upward protruding lip 18 recessed inward from an outer edge 20 of the base 16 and extending along the outer perimeter of the base 16. The lip 18 of the base 16 provides a recessed area which receives a lower edge 22 (FIG. 3) of the cover 14. The cover 14 and the base 16 are ultrasonically welded together where the cover 14 and the base 16 contact each other in the recessed area. Preferably, the cover 14 and the base 16 are sealed together to prevent liquids, such as water, and humidity from entering into the gear box 10. Although a fluid seal may not necessarily be required to practice the present invention. Fluid seals other than or in addition to ultrasonic welding can also be used to prevent fluid from entering inside of the gear box 10. The cover 14 and the base 16 can be secured together by any other alternative suitable means, for example, adhesives, screws, fasteners, and snap-fit structures, etc. Also, the cover 14 and the base 16 can be permanently or removably secured together. The base 16 has upward protruding locating bosses 24 which cooperate with corresponding structure on the cover 14 for easy proper alignment of the cover 14 on the base 16.

The gear box 10 has mounting locations 26 for mounting the gear box 10, for example, inside of an ice-making compartment of the refrigerator/freezer. The mounting locations 26 shown in FIG. 1 are bosses having through-holes. However, the mounting locations 26 can have any suitable structure for mounting the gear box.

Referring to FIG. 1, electrical lead wires 28 extend through a rubber grommet 30 through a wall 32 of the cover 14 of the housing 12. The lead wires 28 are electrically connected to the electrical components inside of the gear box 10 (FIGS. 2 and 3). The lead wires 28 are electrically connected to an electrical power source (not shown) which provides electric power, such as direct current, through the electrical connection to the electrical components inside of the gear box 10. For example, the lead wires 28 can be connected to a control circuit of an ice dispenser of the refrigerator/freezer. The rubber grommet 30 maintains a fluid seal against the wall 32 of the cover 14 and also against the lead wires 28.

Referring to FIG. 1, the gear box 10 has a rotatable output shaft 34 which extends through a wall 36 of the housing 12 and provides rotational driving forces. During use of the gear box 10, the output shaft 34 is engaged with a mating structure, such as a rotating shaft, of an ice dispenser mechanism (not shown) to drive/operate the ice dispenser to dispense ice. The output shaft 34 is shown as a round shaft having opposite flat side portions for quick coupling to the corresponding shafts of the refrigerator/freezer ice dispenser mechanism, and for effectively transmitting torque to the refrigerator/freezer ice dispenser shafts. Other output shaft designs or output mechanisms could be used for the output shaft 34 of the gear box 10. Round shafts, D-shaped shafts, hex shafts, and female shafts are a few examples of suitable alternatives for the output shaft 34. The output shaft 34 is driven at desired speeds, torques and rotational directions (clockwise and/or counter-clockwise) by a gear train 38 (FIG. 2) inside of the gear box 10.

Still referring to FIG. 1, the gear box 10 has a low-profile height. The structure and arrangement of the internal components of the gear box 10 allows the gear box 10 to have a small height. The low-profile height of the gear box 10 significantly reduces the size of the gear box 10 relative to existing gear boxes for ice dispensers. The low-profile height of the gear box 10 allows the gear box 10 to be located at a small space inside of the refrigerator/freezer ice dispensing area. Because the gear box 10 requires less space inside of the refrigerator/freezer there is greater amount of space available for other refrigerator/freezer components. For example, the ice bucket inside of the freezer can be larger and contain more ice because the gear box 10 is smaller. Referring to FIGS. 1 and 3, the housing 12 of the gear box 10 has a first housing portion 40 with a height HI connected to a second housing portion 42 having a height H2. The height H2 of the second housing portion 42 is smaller than the height H1 of the first housing portion 40. Accordingly, there is a step-down or off-set 44 in height from the first housing portion 40 to the second housing portion 42. In an embodiment, the height HI of the first housing portion 40 is about 1.5″ and the height H2 of the second housing portion 42 is about 0.975″. As can be seen in FIG. 3, the first housing portion 40 contains a motor 46 and the second housing portion 42 contains the gear train 38. The output shaft 34 extends upward through a hole 48 in the top wall 36 of the second housing portion 42. See also, FIG. 1.

The components of the gear box 10 inside of the housing 12 will now be described with reference to FIGS. 2-4. FIG. 2 shows a perspective view of the inside of the gear box 10 with the cover 14 removed, FIG. 3 shows a partially exploded, perspective view of the gear box 10, and FIG. 4 shows a perspective view of the gear box 10 with various components removed. The gear box 10 has the motor 46 positioned in a motor holding receptacle 50 of the base 16. A partition wall 52 separates a first portion of the base 16 having the motor holding receptacle 50 from a second portion of the base 16 having the gear train 38. Screws 54 through the partition wall 52 can be used to securely hold the motor 46 in place. The first portion of the base 16 is part of the first housing portion 40 of the housing 12 and the second portion of the base 16 is part of the second housing portion 42 of the housing 12.

The motor 46 is a direct current (DC) motor which is capable of rotating its motor shaft 56 in both clockwise and counter-clockwise directions. The motor shaft 56 is connected to and drives a worm gear (first gear) 58. The motor 46 and worm gear 58 drive the gear train 38. More specifically, the worm gear 58 is engaged with outer teeth 60 of a of a cluster gear (second gear or input gear) 62 which rotates about a gear pin 64. Inner teeth 66 of the cluster gear 62 are engaged with outer teeth 68 of a cluster gear (third gear) 70 which rotates about a gear pin 72. Inner teeth 74 of the cluster gear 70 are engaged with outer teeth 76 of a cluster gear (fourth gear) 78 which rotates about a gear pin 80. The inner teeth 82 of the cluster gear 78 are engaged with teeth 84 of an output gear (fifth gear) 86. The output shaft 34 is carried by the output gear 86 and rotates along with the output gear 86.

The gear train 38 driven by the motor 46 is designed to provide low rotational speed and high torque to the output shaft 34. The low speed, high torque rotation of the output shaft 34 can be beneficial for driving an ice dispenser to crush ice and dispense the crushed ice or to dispense ice cubes. The motor 46 is operated in two directions, clockwise and counter-clockwise. One direction of the motor 46, such as a counter-clockwise direction, operates the output shaft 34 in one direction to provide the function of dispensing ice cubes, for example. The other opposite direction of the motor 46, such as clockwise, operates the output shaft 34 in its opposite direction to provide the function of crushing ice and dispensing the crushed ice, for example.

Referring to FIGS. 2 and 3, one feature of the gear box 10 is that the motor shaft 56 of the motor 46 has an axis which is generally perpendicular (about 90.degree.) to an axis of the cluster gear 62 (generally perpendicular to the gear pin 64). Another feature of the gear box 10 is that the axis of the motor shaft 56 is generally perpendicular (about 90.degree.) to an axis of the output shaft 34. Also, the gear pins 64, 72, 80 and the output shaft 34 have axes which are generally parallel. Accordingly, the axis of the motor shaft 56 is generally perpendicular (about 90.degree.) to the axes of all of the gears 62, 70, 78, 86 in the gear train 38.

Another feature of the gear box 10 is that the entire gear train 38 is located in front of the motor 46 (on the side of the motor 46 having the motor shaft 56) without extending above the uppermost portion of the motor 46 or below the lowermost portion of the motor 46. Referring to FIG. 2, the motor 46 and the gear train 38 are both supported by the base 16 which has a planer bottom wall 88. In the illustrated embodiment of the present invention, the motor 46 has opposed flat sides. One flat side of the motor 46 rests against the bottom wall 88. The other, opposite flat wall of the motor 46 represents the uppermost portion of the motor 46, which can be the maximum height of the motor 46. In other words, the motor 46 has a maximum height which extends a certain distance above the bottom wall 88 of the base 16. It can be advantageous to use a motor 46 which has the opposed flat sides rather than a round or cylindrical motor. The flat-sided motor enhances the low-profile height of the gear box 10. The gear train 38 also extends upward above the base 16. The maximum height of the gear train 38 above the base 16 does not exceed the maximum height of the motor 46 above the base 16. This height relationship between the motor 46 and gear train 38 can also be understood by viewing FIG. 1 in which the height H2 of the second housing portion 42 containing the gear train 38 is lower than the height H1 of the first housing portion 40 containing the motor 46. The height of the output shaft 34 of the gear box 10 is not considered for the purposes of the height relationship between the motor 46 and the gear train 38. The structure of the motor 46 and the gear train 38 allow for the gear box 10 to have its low-profile height.

Referring to FIGS. 2 and 3, the gear box 10 has a printed circuit board (PCB) assembly 90. The PCB assembly 90 is contained within the first housing portion 40 of the gear box 10. The PCB assembly 90 is electrically connected to the lead wires 28 and to the motor 46 to permit electrical power to be supplied to the motor 46. The PCB assembly 90 has a circuit board 92 standing on an edge of the circuit board 92 and extending upward away from the base 16. Retainers 94 hold the circuit board 92 in place. The retainers 94 are also shown in FIG. 4. Referring to FIGS. 2 and 3, the height of the upstanding PCB assembly 90 does not extend beyond the maximum height of the motor 46. The low height of the upstanding PCB assembly 90 contributes to maintaining the low height of the first housing portion 40 (FIGS. 1 and 2).

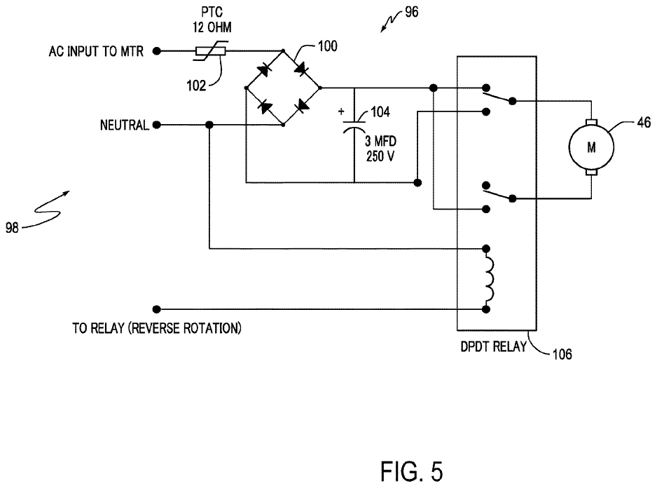

FIG. 5 shows a schematic diagram of an electrical circuit 96 for the gear box 10. An AC power source 98 is provided from the refrigerator/freezer to the PCB assembly 90. A bridge rectifier 100 converts the AC current to DC current to power the DC motor 46. The electrical circuit 96 of the circuit board 92 has a positive temperature coefficient (PTC) 102 which provides protection for the windings of the motor 46. A capacitor 104 is electrically connected to the circuit board 92 and provided in the electrical circuit for filtering, and thus, the capacitor 104 provides for smoother operation of the motor 46. The PCB assembly 90 has a relay (switch) 106, such as a DPDT relay, used to reverse the polarity of the DC current applied to the motor 46. The motor 46 can be operated in a first direction (counter-clockwise) to dispense ice cubes, for example. The relay 106 can change the operation of the motor 46 to a second, reverse direction (clockwise). The motor 46 operating in the second direction can be used to crush ice and dispense the crushed ice, for example. Accordingly, the relay 106 can reverse the motor operation for alternatively dispensing ice cubes and crushed ice.

The refrigerator/freezer (not shown) has an ice dispensing selector which allows an operator to select ice cubes or crushed ice. When ice cubes are selected by the operator, AC power 98 is supplied to the PCB assembly 90 which operates the relay 106 in a first mode. The relay 106 supplies the DC current (converted from the AC current) to the motor 46 to operate the motor 46 in a first direction. The motor 46 drives the gear train 38 which rotates the output shaft 34 in a first direction. The rotating output shaft 34 drives the ice dispenser to dispense ice cubes. When crushed ice is selected by the operator, AC power 98 is supplied to the PCB assembly 90 which operates the relay 106 in a second mode. The relay 106 supplies the DC current (converted from the AC current) to the motor 46 to operate the motor 46 in a second, reverse direction. The motor 46 drives the gear train 38 which rotates the output shaft 34 in a second, reverse direction. The reverse rotating output shaft 34 drives the ice dispenser to crush ice and dispense the crushed ice. In an embodiment of the present invention, the motor 46 operates with about the same rotational speed and torque in both the clockwise and counter-clockwise directions with no load or equal loads on the motor 46. There may be different loads placed on the motor 46 during use of the gear box 10 which would, of course, result in different operational rotational speeds and torques of the motor 46, for example during clockwise and counter-clockwise rotation.

The gear box 10 can be designed to operate at various desired electrical voltages. For example, the operation voltage for the gear box 10 may vary at either 50 Hz or 60 Hz from 12 to 48 volts of direct current (VDC) or from 120 to 220 volts of alternation current (VAC) rectified. The motor 46 is selected for its operational 30 characteristics in conjunction with the operation voltage and the desired rotational speed and torque.

Operation of the gear train 38 will now be further described. When electrical power is supplied to the motor 46, the motor 46 rotates the motor shaft 56 which rotates the worm gear 58. The worm 58 is engaged with and rotates the cluster gear 62. The cluster gear 62 is engaged with and rotates the cluster gear 70. The cluster gear 70 is engaged with and rotates the cluster gear 78. The cluster gear 78 is engaged with and rotates the output gear 86 which rotates the output shaft 34. When the operation of the motor 46 is reversed, all of the gears 58, 62, 70, 78, 86 rotate in reverse directions as does the output shaft 34. The gear train 38 and gears 58, 62, 70, 78, 86 are designed to provide desired rotational outputs of the output shaft 34. The gear box 10 provides about the same rotational speed and torque of the output shaft 34 for clockwise and counter-clockwise rotation of the output shaft 34 when there is no load or about equal loads placed on the output shaft 34. There may be different loads placed on the output shaft 34, and thus, the gear train 38 and the motor 46, during use of the gear box 10. The different loads would, of course, result in different operational rotational speeds and torques of the output shaft 34, for example, during clockwise and counter-clockwise rotation of the output shaft 34. When the output shaft 34 drives the ice dispenser to dispense ice cubes there is a relatively lower load placed on the output shaft 34, gear train 38 and motor 46 compared to a relatively higher load when the output shaft 34 drives the ice dispenser to crush ice and dispense the crushed ice. The present invention can be practice using alternative gears and gear trains as desired.

### Second Gear Box Embodiment

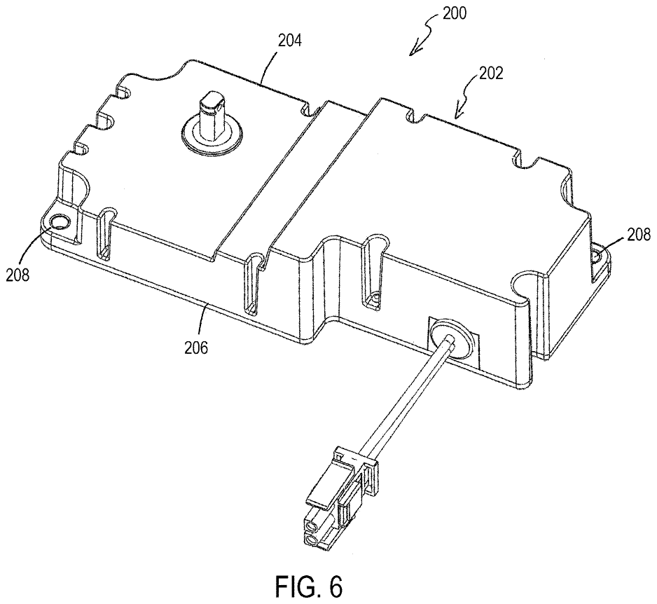

Another example of the gear box 200 according to the present invention is shown in FIGS. 6-8. FIG. 6 is a perspective, exterior view of the gear box 200. As with the gear box 10 discussed in the first embodiment, the gear box 200 has a closed housing 202 having a cover 204 and a base 206, which is constructed in the same manner as the first gear box 10. The gear box 200 has mounting locations 208 for mounting the gear box, for example, inside of an ice-making compartment of the refrigerator/freezer. Notably, this gear box 200 has at least two fewer mounting locations 208 than the previous embodiment. This gear box 200 is particularly suited for installation into a bottom freezer unit and a side-by-side refrigerator.

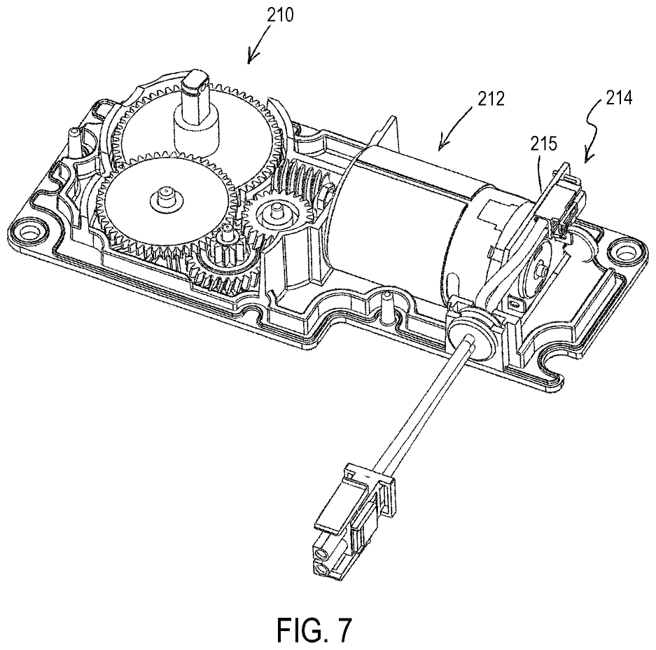

FIG. 7 is a perspective view of the inside of the gear box 200 with the cover 204 removed. The components of the gear box 200 inside the housing 202 are the same and operate in the same manner as those described previously with regard to the first embodiment, namely, a gear train 210, a motor 212, and a printed circuit board assembly 214 including a printed circuit board 215. In this embodiment, a round motor may be used rather than the flat sided motor.

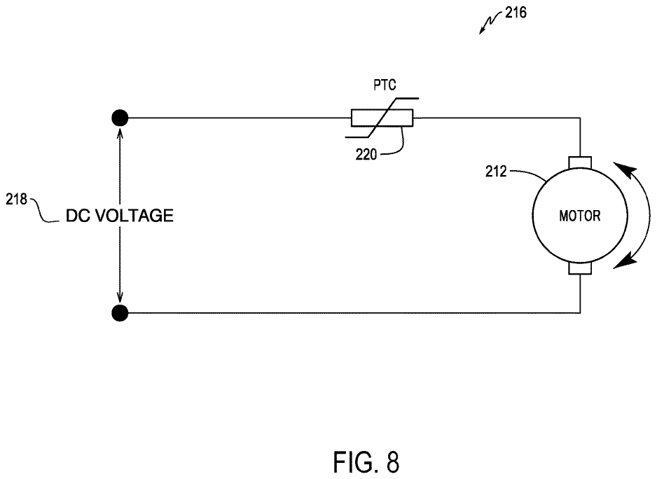

FIG. 8 shows a schematic diagram of an electrical circuit 216 for the gear box 200. This particular electrical circuit is a simplified version, as many of the previous components, including the bridge rectifier 100, capacitor 104 and relay (switch) 106, are all located in a mother board of the appliance (not shown). Thus, a DC voltage connector 218 and positive temperature coefficient (PTC) 220 remain within the PCB assembly 214 for this embodiment. Relocation of the various components of the PCB assembly results in an even more compact and cost-efficient gear box useful in a variety of appliance applications.

Numerous modifications and variations of the present invention are possible in light of the above teachings. The present invention has been described in terms of a gear box for use in refrigerators/freezers for dispensing ice. However, the present invention is broader than that and can be used for other applications. Also, different gear trains or force transfer mechanisms can be used to drive the output shaft 34 by the motor 46. For example, instead of using the worm gear 58 as the drive gear from the motor 46, a bevel gear, a helical gear (preferably a 45.degree. helix angle) or any other type of gear or combination of gears could be used. The other gears could also be changed as desired.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

### High Vibration Motor Embodiment

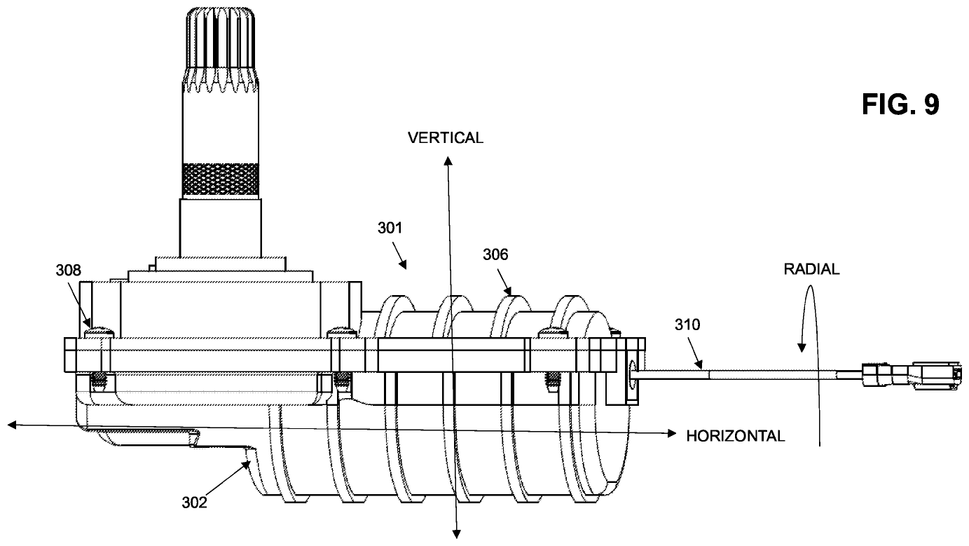

Another example of a motor according to embodiments is shown in FIGS. 9-15.

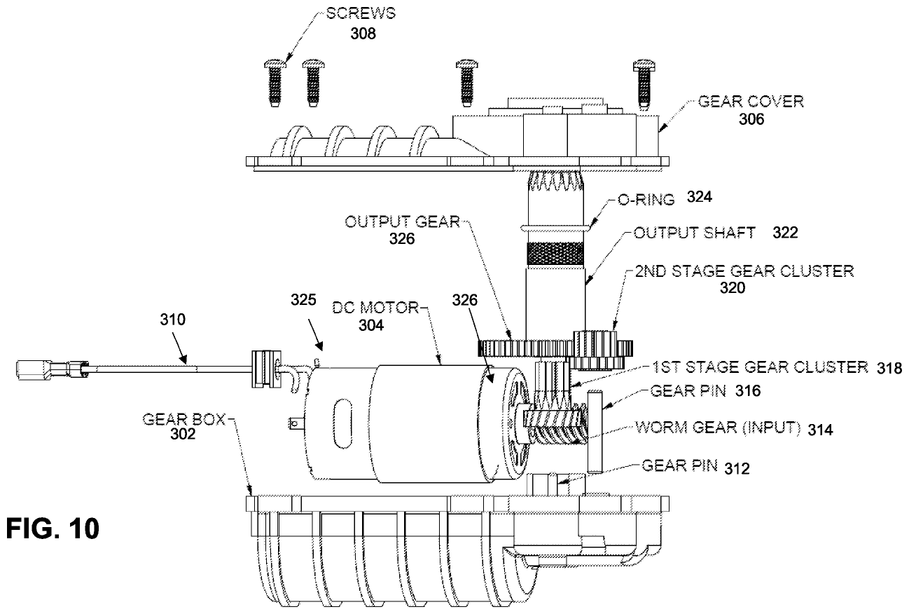

FIG. 9 is a side view of a high vibration motor in accordance with some embodiments. The motor system (also referred to as a “motor”) includes housing. The housing 301 includes a gear cover 306, a gear case 302 that are screwed together using fasteners 308 (e.g., screws). The components of the motor system are more evident from FIG. 10, which is a side exploded view of the high vibration motor of FIG. 9 in accordance with some embodiments.

As shown in FIG. 10, the motor system further includes a motor 304 and a gear system. The gear series includes a worm gear 314, a first stage gear cluster 318, a second stage gear cluster 320, an output gear 326, a gear pin 316 and 312, an output shaft 322 and an o-ring 324, all of which are described above with respect to FIGS. 1-8. The motor 304 may be a DC motor, also as described above with respect to FIGS. 1-8.

The motor 304 is configured to be received between the gear cover 306 and the gear box 302, when assembled using the fasteners 308 to attach the gear cover 306 with the gear box 302. The motor 304 includes a first end 325 and a second end 326, where the second end is proximal to the gear system, and the first end is at an end of the motor 304 opposing the second end.

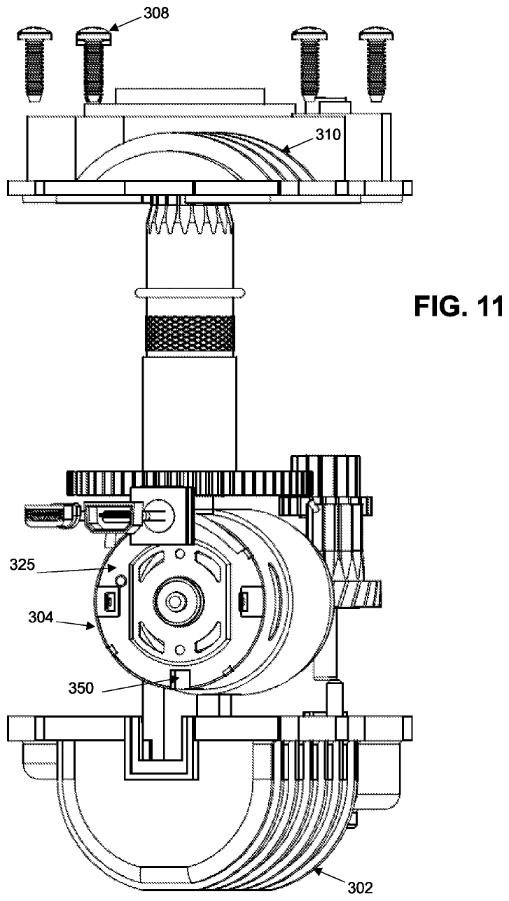

As is described below with reference to FIGS. 11-15, the motor 304 is configured to be seated in and/or held by the housing 301 securely so that the motor 304 does not move in any direction (e.g., horizontally, vertically, and axially) relative to the housing 301.

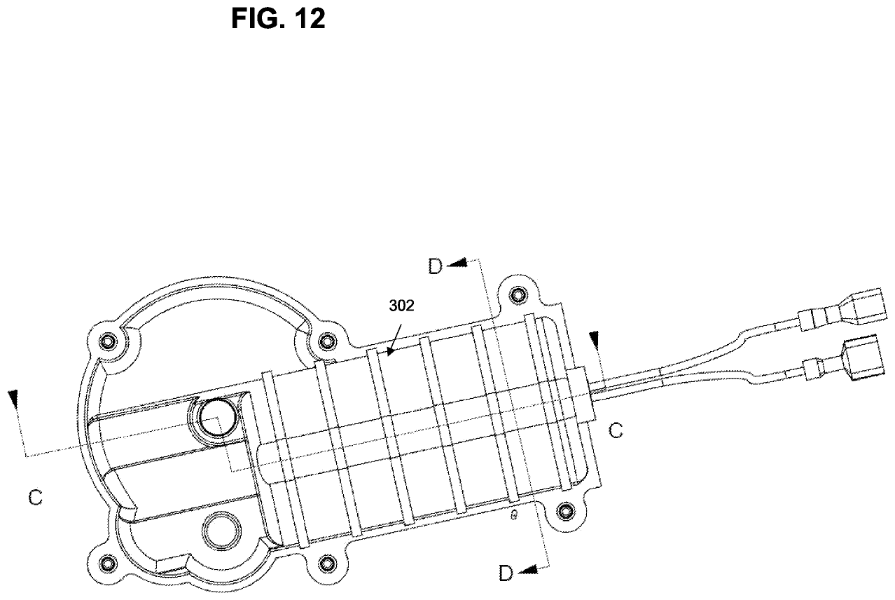

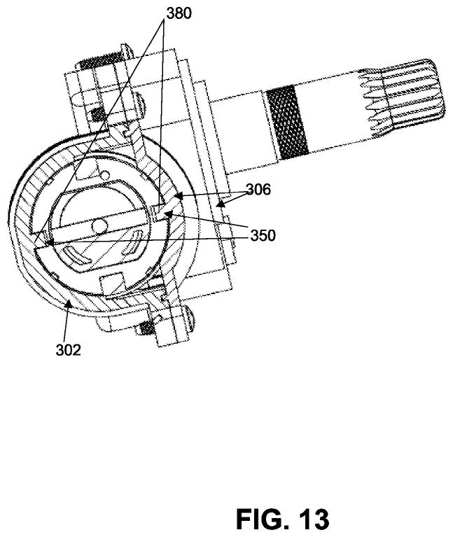

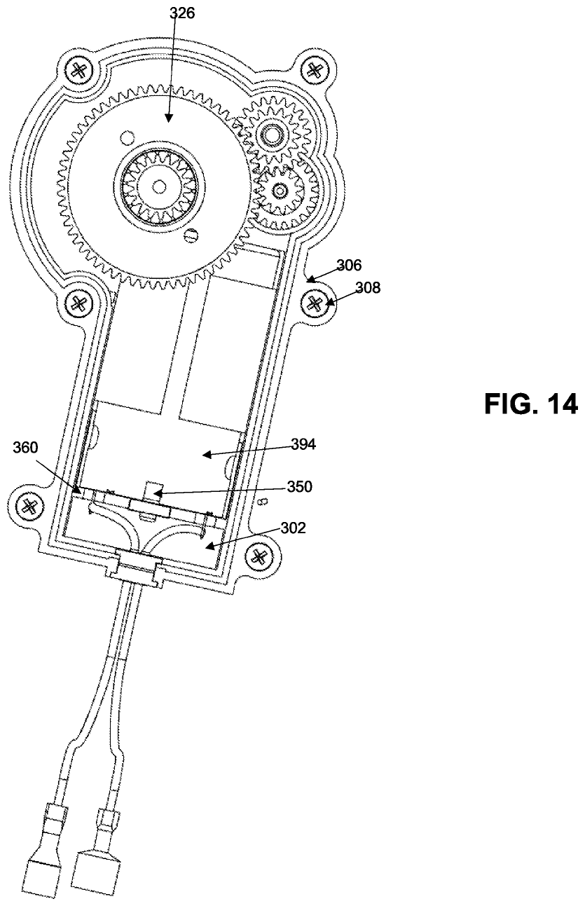

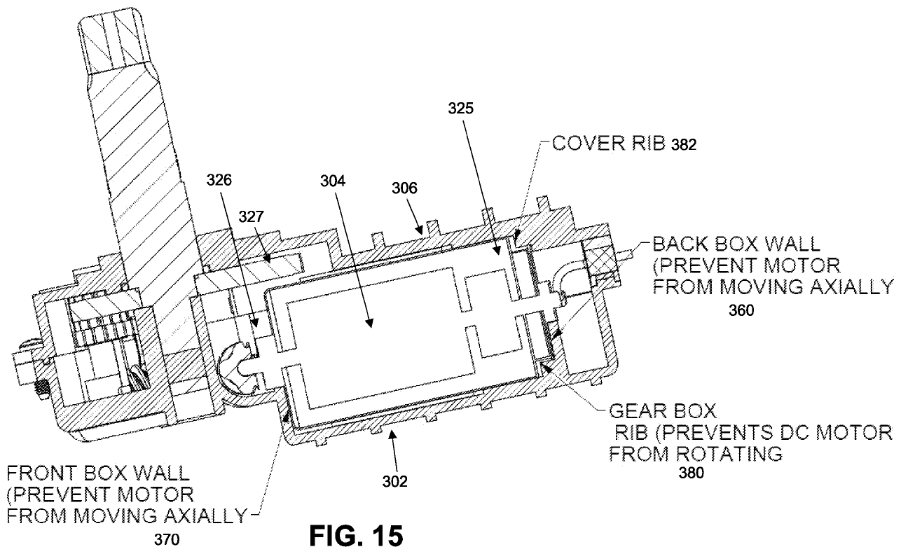

FIGS. 11-15 will now be generally described. FIG. 11 is a front exploded view of the high vibration motor of FIG. 10 in accordance with some embodiments. FIG. 12 is a bottom view of the high vibration motor of FIG. 9 in accordance with some embodiments, and FIG. 13 is a front view of the high vibration motor of FIG. 9 taken along line D-D shown in FIG. 12 in accordance with some embodiments. FIG. 14 is a top view of the high vibration motor of FIG. 9 with the gear cover removed, in accordance with some embodiments. FIG. 15 is a front view of the high vibration motor of FIG. 9 taken along line C-C shown in FIG. 12 in accordance with some embodiments.

The components in each of these figures will now be described and reference should be taken using FIGS. 11-15.

### Radial Direction Preventing/limiting

First, the motor is prevented from moving as a whole in the radial direction, which is shown in FIG. 9. To accomplish this, the motor 304 includes at least one notch 350 (e.g., 2 notches located 180 degrees from each other) at the first end 325 of the motor 304. However, each notch 350 could be located at the second end 326 of the motor instead of or in addition to notch(es) at the first end 325 of the motor. The notches 350 can be seen in FIGS. 11, 13, 14, and 15.

Regardless, each notch 305 in the motor 304 has a corresponding rib 380 located on an interior portion of the housing (as shown in FIGS. 13 and 15). Each of such ribs 380 are referred to herein a “radial rib”. Further, each of the radial ribs 380 located proximate to the first end 325 of the motor are referred to herein as the first end radial ribs, and each of such radial ribs 380 for located proximate to the second end 326 of the motor 304 are referred to herein as the second end radial ribs 380.

Each radial rib 380 is configured to prevent or stop any rotation of the motor 304 in a radial direction relative to the housing by being secured in a corresponding notch 350 of the motor 304. In this regard, the housing (e.g., gear cover 306 and/or gear box 302) includes the radial ribs 380 and such radial ribs 380 are effectively locking protrusions that lock into the notches of the motor 304 so that movement between the housing and the motor is prevented limited and/or halted. This is because any forces or torque from the motor in a radial direction are then absorbed by the housing thereby locking the motor 304 in place.

Moreover, one or more of the radial ribs 380 may be located in the gear cover 306 while other one or more of the radial ribs 380 may be located in gear box 302. It should be noted that there could be one radial rib 380 or a plurality of radial ribs 380 and the radial ribs 380 could be wholly located in the gear cover 306 or wholly located in the gear box 302. In any event, the radial ribs 380 are configured to prevent or limit movement of the motor in the radial direction. However, it should be understood that the radial ribs 380 prevent or limit movement of the housing of the motor but do not have any effect on the motor shaft to rotate the worm gear 314 as the motor shaft is still able to rotate freely relative to the motor housing. This allows the motor as a whole to be stable so that the only movement allowed by the motor is the motor shaft turning the worm gear 314.

### Horizontal/axial Direction Preventing/limiting

Second, the motor is prevented from being moved in the horizontal or lateral direction (i.e., axially), which, as shown in FIG. 9, is a direction established along a longitudinal direction defined by a line connecting the center of the second end 326 of the motor to the first end 325 of the motor. This movement is movement in an axial direction (or along a line aligned with the motor shaft axis.

To accomplish this, the housing includes end ribs 360 and 370. For example, the gear box 302 may include a first end rib 380 located at the first end 325 of the motor, and the gear cover 306 may include a second end rib 370 (also referred to herein as a “front box wall”) located at the second end 326 of the motor. The first end rib 380 is configured to hold the first end 325 thereby limiting movement of the first end 325 in a first lateral direction toward the second end 326. The first lateral direction is a direction defined by a vector line starting at the first end 325 toward the second end 326.

Conversely, the second end rib 370 is configured to hold the second end 326 thereby limiting movement of the second end 326 in a second lateral direction toward the first end 325. The second lateral direction is a direction defined by a vector line starting at the second end 326 toward the first end 325.

In this regard, the end ribs hold the motor laterally so that the motor does not move or vibrate horizontally or laterally. It should be noted that the end ribs 370, 380 can be both located in the gear cover 306 or both in the gear box 302 or one in each of the gear cover 306 and in the gear box 302 and the present invention should not be limited to the location of the end ribs.

It should also be noted that the end ribs snuggly compress the motor so that there is a first constant force applied to the motor in the first lateral direction by one of the end ribs and second constant force applied to the motor in the second lateral direction by the other of the end ribs so that there are constant forces applied to the motor to hold the motor in place. These forces need not be spring loaded and may be a result of the motor fitting tightly between the two end ribs.

It should be noted that there may be only one end rib or any number of end ribs. Also, it should be understood that other components in the motor system may act as an end rib and the end rib need not be an integral component of the housing.

### Vertical Direction Preventing/Limiting

Third, the motor is prevented from being moved in the vertical direction, which is a direction that is perpendicular to the horizontal or lateral direction defined above. For example, as shown in FIG. 9, the vertical direction is defined as a direction between the gear cover 306 and the gear box 302 or a direction that is perpendicular to the line defined between the first end and the second end.

To prevent movement in the vertical direction, the gear cover 306 and the gear box 302 include ribs that are located on opposing sides of the motor but in an interior portion of the gear cover 306 and the gear box 302. Each of the vertical ribs may extend radially around the motor or may be a protrusion.

The vertical ribs snuggly compress the motor so that there is a constant force applied to the motor in a first vertical direction by one of the end ribs and second constant force applied to the motor in a second vertical direction opposite of the first vertical direction by the other of the end ribs so that there are constant opposing vertical forces applied to the motor to hold the motor in place vertically. These forces need not be spring loaded and may be a result of the motor fitting tightly vertically between the two end ribs.

In this regard, the vertical ribs hold the motor vertically so that the motor does not move or vibrate vertically. It should be noted that the vertical ribs can be both located in the gear cover 306 or both in the gear box 302 or one in each of the gear cover 306 and in the gear box 302 and the present invention should not be limited to the location of the vertical ribs.

The vertical ribs and the end ribs do not have space between the motor and the vertical ribs and the end ribs, respectively. This allows the motor to withstand high vibration environments because the motor will not vibrate (or substantially suppress the vibrations to be less than 1%, 5% or 10% of the vibrations that would otherwise occur).

As mentioned above, the gear structure of the high vibration motor system may be the same as the embodiments discussed above with regard to FIGS. 1-8.

It should be noted that there may be a clearance 327 between the motor and the output gear 326 so that the motor does not interfere with movement of the output gear 326, which extends vertically over the motor, in some embodiments.

It should also be noted that the wires 310 may exit the housing as shown in FIG. 9 but alternatively could exit the gear cover 306 vertically or exit the gear box 302.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is

1. A motor system comprising:
a motor configured to be received within the housing and comprising:
a first end,
a motor shaft located at the first end, and
a second end;
a housing comprising:
a gear box base;
a first end rib that is configured to hold the first end thereby limiting movement of the first end in a first lateral direction toward the second end,
a second end rib that is configured to hold the second end thereby limiting movement of the second end in a second lateral direction toward the first end,
a first radial rib configured to limit movement of the motor in a vertical direction perpendicular to the first lateral direction,
a protrusion to fit in the notch of the motor to prevent radial movement of the motor. and
a cover, wherein the cover is configured to be secured to the gear box base;
a gear train configured to be received inside of the housing and driven by the motor shaft, the gear train located on a side of the motor having the motor shaft; and
a rotatable output shaft extending through a wall of the housing and rotatably driven by the gear train.

2. The motor system according to claim 1, wherein the gear train comprises: a first cluster gear having outer teeth engaged with a gear attached to the motor shaft; a second cluster gear having outer teeth engaged with inner teeth of the first cluster gear; a third cluster gear having outer teeth engaged with inner teeth of the second cluster gear; and an output gear having teeth engaged with inner teeth of the third cluster gear, the output gear engaged with the output shaft.

3. The motor system according to claim 2, wherein the motor shaft is generally perpendicular to an axis of the first cluster gear.

4. The motor system according to claim 1, wherein the first and second end ribs are constantly applying opposing forces to the motor while the first radial rib is also applying a force to the motor to prevent any vibration of the motor relative to the housing in an axial direction, a vertical direction, and a radial direction.

5. The motor system according to claim 1, wherein the first and second end ribs and the first radial rib are integral parts of the housing.

6. The motor system according to claim 1, wherein the first and second end ribs and are integral parts of the gear box and the protrusion is an integral part of the housing.

7. The motor system according to claim 1, further comprising a second radial rib opposing the first radial rib, wherein the second radial rib and the first radial rib are integral parts of the housing.

8. The motor system according to claim 1, further comprising a second protrusion to fit in a second notch of the motor to assist in preventing radial movement of the motor.

9. A motor housing for housing a motor comprising:
a gear box;
at least one end rib that is configured to prevent the motor from axial movement in an axial direction,
a radial rib configured to prevent movement of the motor in a vertical direction perpendicular to the axial direction,
a protrusion to fit in a notch of the motor to prevent radial movement of the motor; and
a gear cover configured to be secured to the gear box;
wherein a gear train is configured to be received inside of the housing and driven by a motor shaft of the motor, the gear train located on a side of the motor having the motor shaft; and
wherein a rotatable output shaft extends through a wall of the housing and rotatably driven by the gear train.

10. The motor housing according to claim 9, wherein the first and second end ribs are constantly applying opposing forces to the motor while the first radial rib is also applying a force to the motor to prevent any vibration of the motor relative to the housing in an axial direction, a vertical direction, and a radial direction.

11. The motor housing according to claim 9, wherein the first and second end ribs and the first radial rib are integral parts of the housing.

12. The motor housing according to claim 9, wherein the first and second end ribs and are integral parts of the gear box and the protrusion is an integral part of the housing.

13. The motor housing according to claim 9, further comprising a second radial rib opposing the first radial rib, wherein the second radial rib and the first radial rib are integral parts of the housing.

14. The motor housing according to claim 9, further comprising a second protrusion to fit in a second notch of the motor to assist in preventing radial movement of the motor.
